(19) United States
(12) Patent Application Publication
(10) Pub. No.: US 2025/0076007 A1
(43) Pub. Date: Mar. 6, 2025

(54) Rollup Bullet Proof/Cut Resistant Panel

(71) Applicant: Qualitas Manufacturing, Inc., Itasca, IL (US)

(72) Inventor: James V. Miller, Lake Villa, IL (US)

(73) Assignee: Qualitas Manufacturing, Inc., Itasca, IL (US)

(21) Appl. No.: 18/819,800

(22) Filed: Aug. 29, 2024

Related U.S. Application Data
(60) Provisional application No. 63/535,872, filed on Aug. 31, 2023.

(51) Int. Cl. F41H 5/24; E06B 9/15; E06B 9/58

(52) U.S. Cl. CPC F41H 5/24; E06B 9/15; E06B 9/581; E06B 2009/1544

(57) ABSTRACT

A ballistic panel for a rolling shutter assembly covering an opening may include a ballistic panel cover and a plurality of ballistic sheets disposed within the ballistic panel cover. Each ballistic sheet may be fabricated from a high-strength material and have a sheet upper edge, a sheet lower edge and oppositely disposed sheet lateral edges. The plurality of ballistic sheets may be attached to each other proximate the sheet upper edges and not attached to each other along the sheet lower edges and the sheet lateral edges such that the plurality of ballistic sheets slide relative to each other when the plurality of ballistic sheets are rolled up around the sheet upper edges. The ballistic panel may be attached to a shutter curtain of a rolling shutter assembly at the sheet upper edges to roll up around a shutter support member without bunching and rippling.

### CROSS-REFERENCE TO RELATED APPLICATION

This patent application claims the benefit of U.S. Provisional Application No. 63/535,872 filed Aug. 31, 2023, which is incorporated by reference herein.

### TECHNICAL FIELD

The present disclosure relates generally to protective coverings and, more particularly, to rollup bullet proof/cut resistant panels fabricated including anti-ballistic fabrics that are selectively deployable over openings and open areas for protection against discharged ballistic projectiles.

### BACKGROUND

Ballistic curtains are a type of flexible protective barrier designed to absorb and deflect the impact of ballistic threats, such as bullets or shrapnel. Ballistic curtains have a wide range of applications, from military and law enforcement settings to civilian protection in public spaces and buildings. There has been a growing desire to provide ballistic protection in civilian settings, such as schools and hospitals, to protect against the threat of gun violence. Ballistic curtains have emerged as a flexible solution for providing protection in these environments. Specifically, ballistic curtains can be used to cover hallways, doorways and other openings in these settings, providing a layer of protection between staff, patients, and students and potential threats.

To achieve the desired level of ballistic protection, ballistic curtains can be formed in whole or in part from high-strength materials, such as Kevlar®, Spectra Shield®, Dyneema® or the like, and can include multiple layers of material as necessary to withstand the anticipated threats, with the edges of the layers being secured together around the perimeter of the ballistic curtain. However, multi-layer ballistic curtains can be more difficult to roll up because the radii of the outer layers are greater than the inner layers when the curtain is rolled up. This can cause the material to bunch up and make it challenging to roll the curtain up tightly.

### SUMMARY OF THE DISCLOSURE

In one aspect of the present disclosure, a ballistic panel for a rolling shutter assembly covering an opening is disclosed. The ballistic panel may include a ballistic panel cover and a plurality of ballistic sheets disposed within the ballistic panel cover. Each ballistic sheet may be fabricated from a high-strength material and have a sheet upper edge, a sheet lower edge and oppositely disposed sheet lateral edges. The plurality of ballistic sheets may be attached to each other proximate the sheet upper edges and not attached to each other along the sheet lower edges and the sheet lateral edges such that the plurality of ballistic sheets slide relative to each other when the plurality of ballistic sheets are rolled up around the sheet upper edges.

In another aspect of the present disclosure, a rolling shutter assembly for covering an opening of a structure is disclosed. The rolling shutter assembly may include a shutter support member mounted at a top wall of the opening, a shutter curtain coupled to the shutter support member so that rotation of the shutter support member rolls the shutter curtain onto and unrolls the shutter curtain from the shutter support member, and a ballistic panel having a panel upper end, a panel lower end and oppositely disposed panel lateral sides. The ballistic panel may include a plurality of ballistic sheets, wherein each ballistic sheet may be fabricated from a high-strength material and have a sheet upper edge, a sheet lower edge and oppositely disposed sheet lateral edges. The plurality of ballistic sheets may be attached to each other and to the shutter curtain proximate the sheet upper edges and the plurality of ballistic sheets are not attached to each other along the sheet lower edges and the sheet lateral edges such that the plurality of ballistic sheets slide relative to each other when the shutter curtain and the ballistic panel are rolled up around the shutter support member.

In a further aspect of the present disclosure, a ballistic curtain for covering an opening of a structure is disclosed. The ballistic curtain may include a shutter support member mounted at a top wall of the opening, a shutter curtain coupled to the shutter support member, the shutter curtain comprising a plurality of individual slats and a plurality of hinges interconnecting the plurality of individual slats, and a pair of side tracks each having a U-shaped channel, each of the pair of side tracks mounted to a corresponding one of the opening side walls such that ends of the plurality of individual slats are received within the U-shaped channels when the shutter curtain is unrolled from the shutter support member to cover the opening. The ballistic curtain may further include a ballistic panel having a panel upper end, a panel lower end and oppositely disposed panel lateral sides. The ballistic panel may include a plurality of ballistic sheets, wherein each ballistic sheet may be fabricated from a high-strength material and have a sheet upper edge, a sheet lower edge and oppositely disposed sheet lateral edges. The plurality of ballistic sheets may be attached to each other and to one of the slats proximate the sheet upper edges, and the plurality of ballistic sheets are not attached to each other along the sheet lower edges and the sheet lateral edges such that the plurality of ballistic sheets slide relative to each other when the shutter curtain and the ballistic panel are rolled up around the shutter support member.

Additional aspects are defined by the claims of this patent.

### BRIEF DESCRIPTION OF THE DRAWINGS

FIG. 1 is an isometric view of a rolling shutter assembly that can implement a ballistic curtain in accordance with the present disclosure;

FIG. 2 is a cross-sectional bottom view of a portion of the rolling shutter assembly of FIG. 1 taken through line 2-2 of FIG. 1;

FIG. 3 is a rear view of the rolling shutter assembly of FIG. 1 with a ballistic panel in accordance with the present disclosure installed thereon;

FIG. 4A is a side view of a portion of the rolling shutter of FIG. 3 with a shutter curtain unrolled and at which an upper portion of the ballistic panel is attached;

FIG. 4B is a side view of a bottom portion of the rolling shutter of FIG. 3 with the shutter curtain unrolled and at which a bottom portion of the ballistic panel is attached;

FIG. 5A is the side view of the portion of the rolling shutter of FIG. 4A with the shutter curtain partially rolled up;

FIG. 5B is the side view of the bottom portion of the rolling shutter of FIG. 5B with the shutter curtain partially rolled up;

FIG. 6 is the side view of FIG. 5B with a panel lower end of the ballistic panel attached a base slat of the shutter curtain by an elastic cord and hook;

FIG. 7 is the rear view of FIG. 3 including vertical panel support straps for the ballistic panel in accordance with the present disclosure;

FIG. 8 is the rear view of FIG. 3 including horizontal panel support straps for the ballistic panel in accordance with the present disclosure;

FIG. 9 is the rear view of FIG. 3 including diagonal panel support straps for the ballistic panel in accordance with the present disclosure;

FIG. 10 is a rear view of the rolling shutter assembly of FIG. 1 with a ballistic panel in accordance with the present disclosure installed thereon at a service counter opening;

FIG. 11 is a rear view of an embodiment of a rolling shutter assembly with a ballistic panel in accordance with the present disclosure installed thereon and mounted in a recess of a ceiling to cover a hallway; and

FIG. 12 is a schematic plan view of a portion of a facility in which the rolling shutter assemblies with ballistic panels of FIG. 8 are installed and deployed in a hallway of the facility.

### DETAILED DESCRIPTION

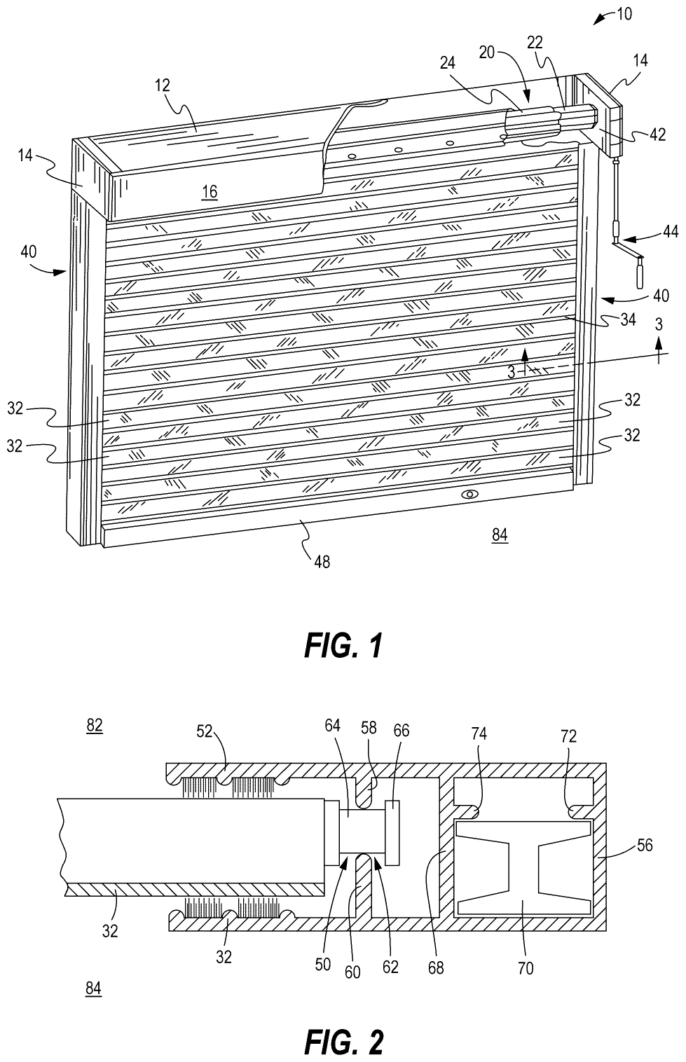

One type of a rolling shutter assembly 10 that may be configured to function as a ballistic curtain in accordance with the present disclosure is shown in FIGS. 1 and 2. Referring to FIG. 1, the rolling shutter assembly 10 has a shutter housing mounted at a top of an opening at which the rolling shutter assembly 10 is installed and which includes a top wall 12, a pair of side walls or end caps 14, a front wall 16, a rear wall 18 and a bottom wall (not shown). A shutter support member 20 is mounted for rotation within the shutter housing. The shutter support member 20 includes a generally cylindrical central shaft 22 and a plurality of mounting members 24 fixed to the central shaft 22. The upper end of a rolling shutter curtain 30 is coupled to one or more of the mounting members 24. In the illustrated embodiment, the rolling shutter curtain 30 is composed of a plurality of individual, elongate slats 32. The slats 32, that may have a curved cross-section to facilitate wrapping around the shutter support member 20, and may be composed of steel, aluminum, or other appropriate material, are interconnected by a plurality of hinges 34, each of which joins together a pair of adjacent slats 32. While slats 32 with curved cross-sections are illustrated herein, it is contemplated that shutter curtains having slats with other cross-sectional shapes may function as ballistic curtains in accordance with the present disclosure. The ends of the slats 32 are disposed within a pair of side tracks 40 having U-shaped channels. The rolling shutter assembly 10 may include a drive motor housing 42 at one of the end caps 14 containing a reversible drive motor, such as a tubular operator (not shown), connected to the central shaft 22 to rotate the central shaft 22 in either direction to raise and lower the rolling shutter curtain 30. The drive motor housing 42 may also include a gear assembly (not shown) connected to the central shaft 22 with a removable hand crank 44 for manually raising and lowering the rolling shutter curtain 30 in the event of a failure of the drive motor, such as during a power outage.

When mounted to protect a window, doorway or other opening, the side tracks 40 of the rolling shutter assembly 10 are positioned on either side of the opening and the shutter housing is positioned over the top of the opening. Alternatively, in some applications, the side tracks 40 and shutter housing are positioned within the opening. When the rolling shutter curtain 30 is not in use, it is rolled up on the shutter support member 20 via the drive motor or, if necessary, the hand crank 44 so that it is at least partially enclosed by the shutter housing. Using the drive motor or the hand crank 44, the rolling shutter curtain 30 is rolled up into the shutter housing until a base slat 46 is disposed at the shutter housing, or unrolled from the shutter support member 20 until the base slat 46 is disposed proximate a bottom surface of the opening.

The slats 32 proximate the hinges 34 may have integral screw bosses for engaging mounting end retention member 50 (FIG. 2) that will in turn engage the corresponding side track 40 of the rolling shutter assembly 10 to retain the rolling shutter curtain 30 within the side tracks 40. The structure of one example of previously known side tracks 40 is illustrated in FIG. 2, which is a horizontal cross-section taken through line 2-2 in FIG. 1 to show the right side track 40 and a corresponding portion of the rolling shutter curtain 30. The left side track 40 has a similar configuration. The side track 40 has a pair of side walls 52, 54, and an end wall 56 defining a U-shaped channel. The side track 40 further includes a first pair of fins 58, 60 that extend inwardly from the side walls 52, 54, respectively, and define a first gap 62 that is wide enough to receive the end retention members 50 extending from the ends of the slats 32 and engage bodies 64 and heads 66 of the end retention members 50 to retain the rolling shutter curtain 30. An inner wall 68 extends from the side wall 52 to the side wall 54 and is disposed between the end wall 56 and the fins 58, 60.

Configured in this way, the side tracks 40 provide multiple channels. The fins 58, 60 and portions of the side walls 52, 54 define a first channel adapted to receive the slats 32 and the base slat 46 when the rolling shutter curtain 30 is unrolled. The fins 58, 60, the inner wall 68 and corresponding portions of the side walls 52, 54 extending there between define a second channel adapted to receive the end retention members 50 as illustrated and described in the Miller '224 patent and the Miller '225 patent. Finally, the end wall 56, the inner wall 68 and the remainder of the side walls 52, 54 define a third channel that receives a nipple 70 extending downward from the corresponding end cap 14 when the end cap 14 is attached to the side track 40. Additional fins 72, 74 extending inward from the end wall 56 and the inner wall 68, respectively, engage the nipple 70 to prevent movement within the third channel. This shutter slat configuration is illustrated and described more fully in U.S. Pat. No. 7,357,171 (hereinafter “the Miller '171 patent”), which is expressly incorporated by reference herein for all purposes. Other examples of shutter assemblies with end retention are shown in the Miller '224 patent and U.S. Pat. No. 6,095,225 (hereinafter “the Miller '225 patent”), which are expressly incorporated by reference herein for all purposes. Other configurations of slats and interconnecting hinges are well known in the art and are contemplated by the inventor as having use in rolling shutter assemblies 10 with ballistic panels in accordance with the present disclosure.

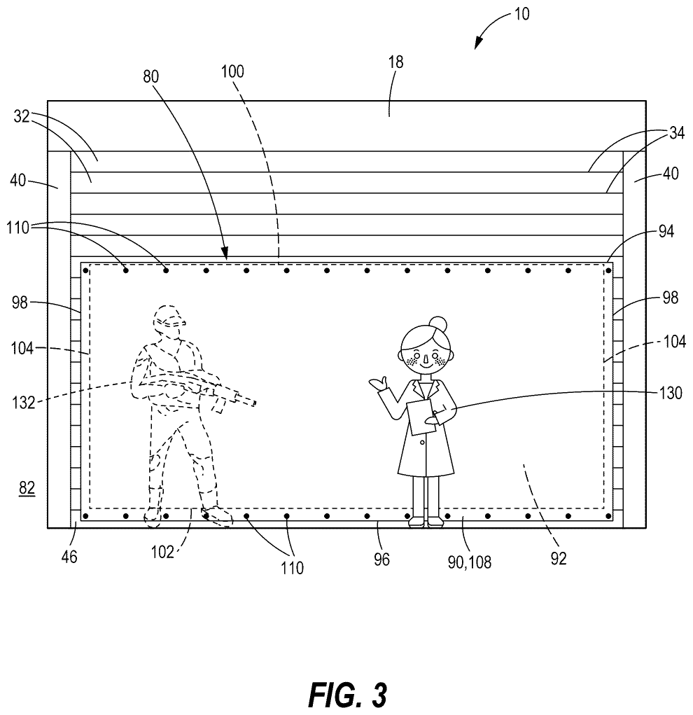

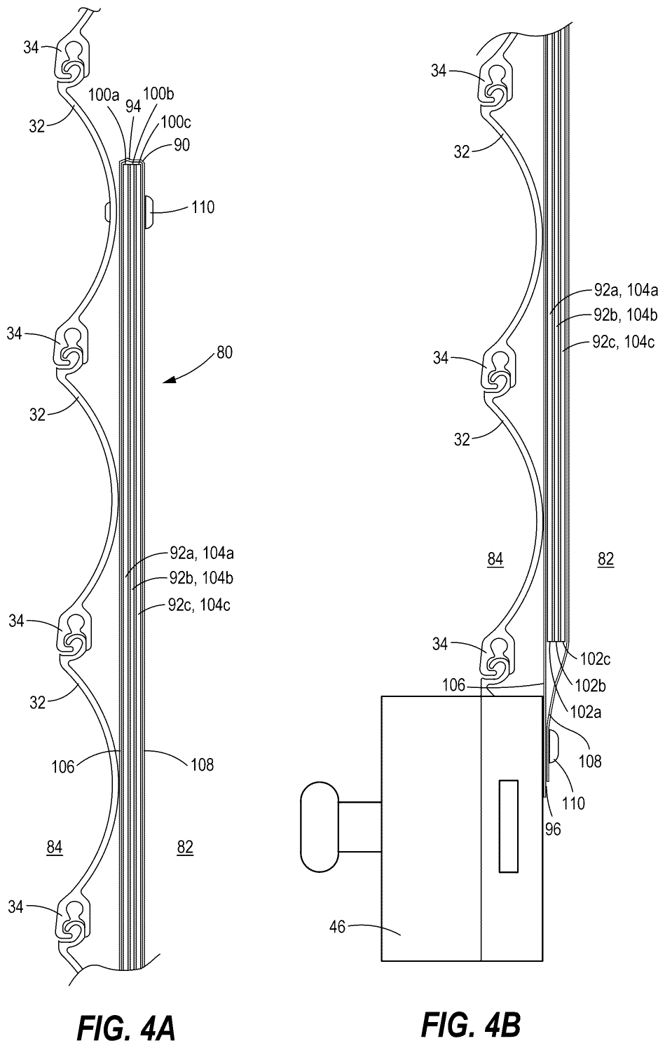

The rolling shutter assembly 10 may be converted into a ballistic and cut resistant curtain by adding ballistic material at installation or at a later time as an after-market enhancement. FIG. 3 illustrates the rolling shutter assembly 10 including a ballistic panel 80 attached to an outer side 82 of the rolling shutter curtain 30. For purposes of the following discussion, the outer side 82 of the rolling shutter curtain 30 is the side facing away from the shutter support member 20 when the rolling shutter curtain 30 is rolled up, and an inner side 84 (FIGS. 1 and 4A) is the side facing toward the shutter support member 20 when the rolling shutter curtain 30 is rolled up. The ballistic panel 80 may be attached to the shutter curtain 30 as shown so that the ballistic panel 80 rolls up and down with the rolling shutter curtain 30 to alternately uncover and cover the opening at which the rolling shutter assembly 10 is installed. In alternative embodiments, the ballistic panel 80 may be attached to the inner side 84, or ballistic panels 80 maybe attached to both sides 82, 84.

As shown in FIGS. 3, 4A and 4B, the ballistic panel 80 may include a ballistic panel cover 90 that encloses a plurality of ballistic sheets 92a-92c. While three ballistic sheets 92 are illustrated in the present embodiment, fewer or more ballistic sheets 92 may be enclosed within the ballistic panel cover 90 as necessary to protect against the force of anticipated ballistic impacts. The ballistic panel 80 may have a panel upper end 94, and panel lower end 96 and panel lateral sides 98. Each of the ballistic sheets 92 may have a sheet upper edge 100 proximate the panel upper end 94, a sheet lower edge 102 proximate the panel lower end 96, and sheet lateral edges 104 that are each proximate a corresponding one of the panel lateral sides 98.

The ballistic panel cover 90 may be fabricated from a material having sufficient strength to retain the ballistic sheets 92 without tearing due to strain caused by ballistic impacts. Such materials may be fiber reinforced, but are not necessarily required to be ballistic materials. The ballistic panel cover 90 may have a cover inside sheet 106 facing and engaging the rolling shutter curtain 30 and a cover outside sheet 108 opposite the cover inside sheet 106 with the ballistic sheets 92 disposed therebetween. The sheets 106, 108 may be joined at the ends 94, 96 and the lateral sides 98 of the ballistic panel 80 to completely enclose the ballistic sheets 92, or one or more of the edges of the sheets 106, 108 may remain detached to allow access to the interior of the ballistic panel cover 90. As shown, the ballistic panel cover 90 is longer than the ballistic sheets 92 so that panel lower end 96 is lower than the sheet lower edges 102 and the ballistic sheets 92 have room to move within the ballistic panel cover 90. In some embodiments, the cover inside sheet 106 may be omitted such that the innermost ballistic sheet 92a faces and engages the rolling shutter curtain 30 and the panel outside sheet 108 is draped over the ballistic sheets 92.

The ballistic sheets 92 may be fabricated from any appropriate ballistic material, such as aramid fabrics like Kevlar®, Spectra Shield® or Dyneema®, with each ballistic sheet 92 having sufficient flexibility to be rolled up onto the shutter support member 20 with the rolling shutter curtain 30 and the other ballistic sheets 92 as discussed further below. As shown in the figures, the ballistic panel cover 90 and the ballistic sheets 92 may be attached to one of the shutter slats 32 at panel upper end 94 by an attachment mechanism 110, such as a plurality of rivets 110 spaced across the ballistic panel 80 and passing through the slat 32, the ballistic panel cover 90 and the ballistic sheets 92 proximate the sheet upper edges 100. If necessary, the ballistic panel cover 90 and/or the ballistic sheets 92 may include reinforcement structures (not shown), such as grommets or the like, to prevent tearing under the strain of ballistic impacts. Of course, alternative attachment mechanisms 110 in the form of attachment hardware, adhesives and the like may be used to secure the ballistic panel 80 to the slat 32 in a manner that will not result in detachment caused by ballistic impacts.

Fabric curtains made from multiple layers of aramid fabrics can be difficult to roll up onto the shutter support member 20 because the ballistic sheets 92 will roll up at different rates. For example, the outer ballistic sheet 92c is at a greater radial distance from a rotational axis of the shutter support member 20 than the outer ballistic sheet 92a, and consequently rolls up at a faster rate because more of the outer ballistic sheet 92c will be rolled onto the shutter support member 20 for a given amount of rotation of the shutter support member 20. If the ballistic sheets 92 are stitched, laminated or otherwise secured at the edges 102, 104 as may occur with previously known multi-layer ballistic panels, the ballistic sheets 92 will bunch up and create ripples in the ballistic panel 80. This bunching can inhibit rolling up the rolling shutter curtain 30 with the ballistic curtain mounted thereto.

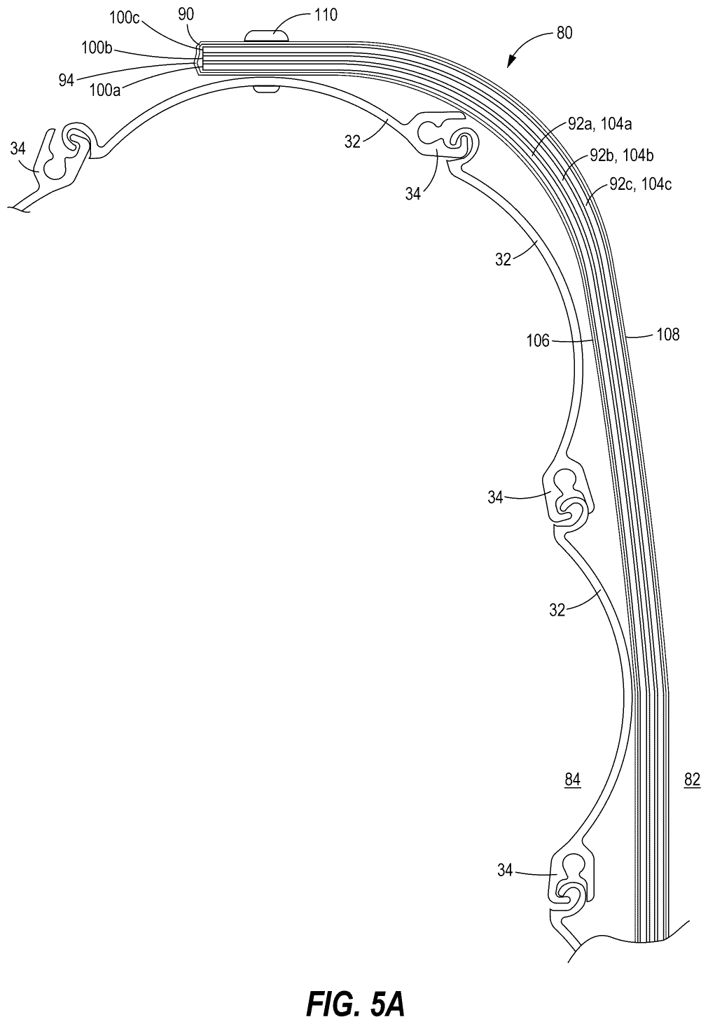

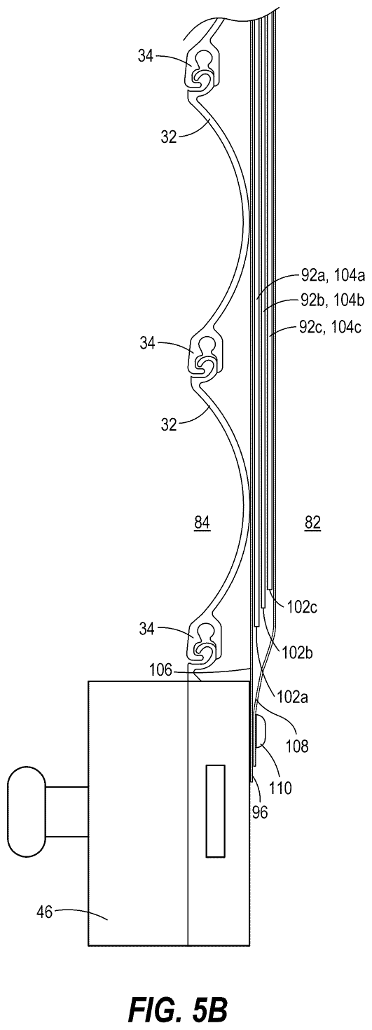

To avoid bunching and rippling with the ballistic panel 80 in accordance with the present disclosure, the sheet lower edges 102a-102c and the sheet lateral edges 104a-104c of the ballistic sheets 92 are not stitched, seamed, laminated or otherwise attached, and instead are left free to move relative to each other. When the shutter curtain 30 is fully unrolled and the ballistic panel 80 hangs vertically, the sheet lower edges 102a-102c may be substantially aligned as shown in FIG. 4B. As the shutter curtain 30 is rolled up onto the shutter support member 20 and shown in FIGS. 5A and 5B, the ballistic panel 80 also begins to roll onto the shutter support member 20 (not shown). With each turn of the shutter support member 20, more of the outer ballistic sheet 92c rolls around the shutter support member 20 than the inner ballistic sheet 92a due to its greater radius from the rotational axis of the shutter support member 20. Because the sheet lower edges 102a-102c and the sheet lateral edges 104a-104c are not secured together, the ballistic sheets 92a-92c can slide along each other and the sheet lower edge 102c can move upward at a greater rate than the sheet lower edges 102b, which can move upward at a greater rate than the sheet lower edge 102a. The inner ballistic sheet 92a may also slide relative to the surface of the shutter curtain 30. This relative movement allows the ballistic sheets 92a-92c to maintain surface-to-surface contact without bunching and rippling so that the shutter curtain 30 and the ballistic panel 80 can roll up tightly around the shutter support member 20. In some embodiments, the inner ballistic sheet 92a may be secured to the shutter curtain 30 at the sheet lower edge 102a to maintain contact with the shutter curtain 30 while still allowing the outer ballistic sheets 92b, 92c to slide relative to the inner ballistic sheet 92a as the shutter curtain is rolled and unrolled.

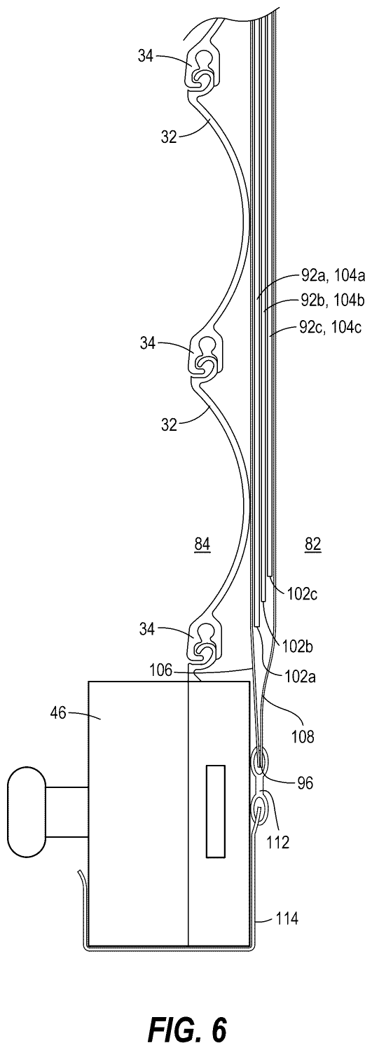

The ballistic sheets 92 may be somewhat stiff and resistant to being rolled up. Consequently, in the illustrated embodiment, the ballistic panel cover 90 may be secured at the panel lower end 96 to the base slat 46 or another slat 32 proximate the bottom end of the shutter curtain 30. As shown, the ballistic panel cover 90 is secured to the base slat 46 by rivets 110 is a similar manner as the panel upper end 94 but without securing the sheet lower edges 102. The ballistic panel cover 90 may be secured to the shutter curtain 30 in a similar manner along the panel lateral sides 98. Alternatively, the panel lower end 96 may be attached with a flexible connection to allow the lower panel end 96 to move relative to the shutter curtain 30 and provide some give in the ballistic panel 80 when impacted similar to a trampoline. In one embodiment shown in FIG. 6, elastic cords 112 may be attached along the panel lower end 96. Hooks 114 may be attached at opposite ends of the elastic cords 112 and have complimentary shapes to the base slat 46 for attachment thereto. Alternative flexible attachment mechanisms are contemplated.

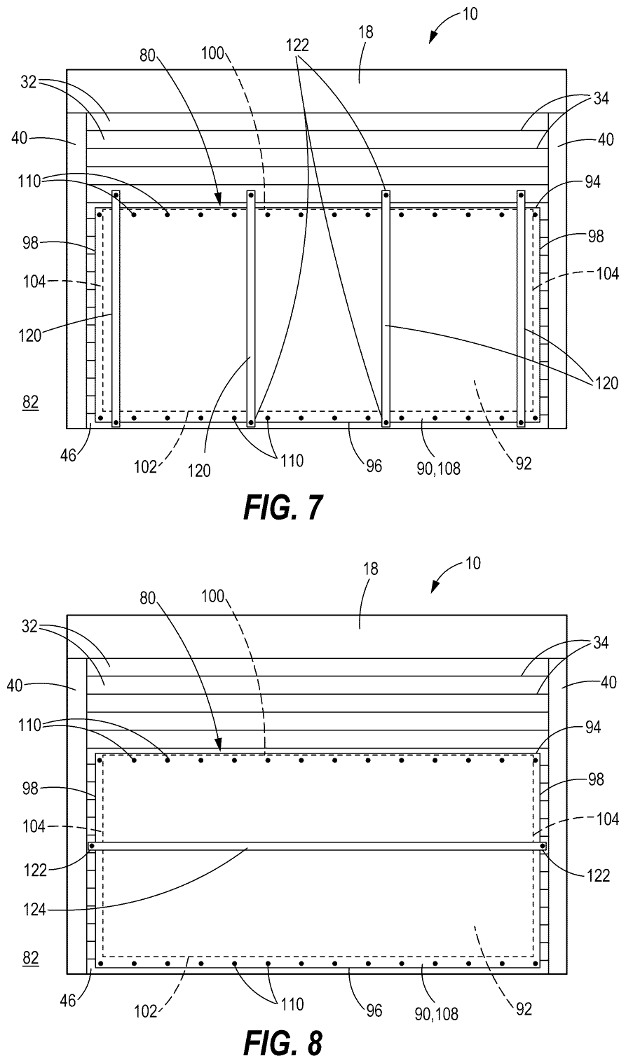

In addition to the ballistic panel cover 92, other support structures may be provided with the ballistic panel 80 to support the ballistic sheets 92 during impacts while still allowing the ballistic sheets 92 to slide relative to each other and to the shutter curtain 30 to roll up onto the shutter support member 20. In one embodiment, panel support straps may be attached to the shutter curtain 30 and overlie the ballistic panel 80 on the outer side 82 such that the panel support straps assist in resisting impacts on the ballistic panel 80 from the inner side 84 of the rolling shutter assembly 10. FIG. 7 illustrates an embodiment where plurality of vertical panel support straps 120 are spaced horizontally across the cover outside sheet 108. The vertical panel support straps 120 may be secured to the shutter curtain 30 by attachment mechanisms 122 that may be similar to the attachment mechanisms 110 described above. Upper ends of the vertical panel support straps 120 may be attached to a shutter slat 32 above the ballistic panel 80 and the lower ends may be attached to the base slat 46 or other shutter slat 32 below the ballistic panel 80 and be loose enough so that the ballistic sheets 92 are not constrained against the relative sliding movement that allows the ballistic sheets 92 to roll up around the shutter support member 20. The outermost vertical panel support straps 120 may be disposed proximate the sheet lateral edges 104 to limit movement of the sheet lateral edges 104 when attachment mechanisms are not used to secure ballistic panel cover 90 at the panel lateral sides 98.

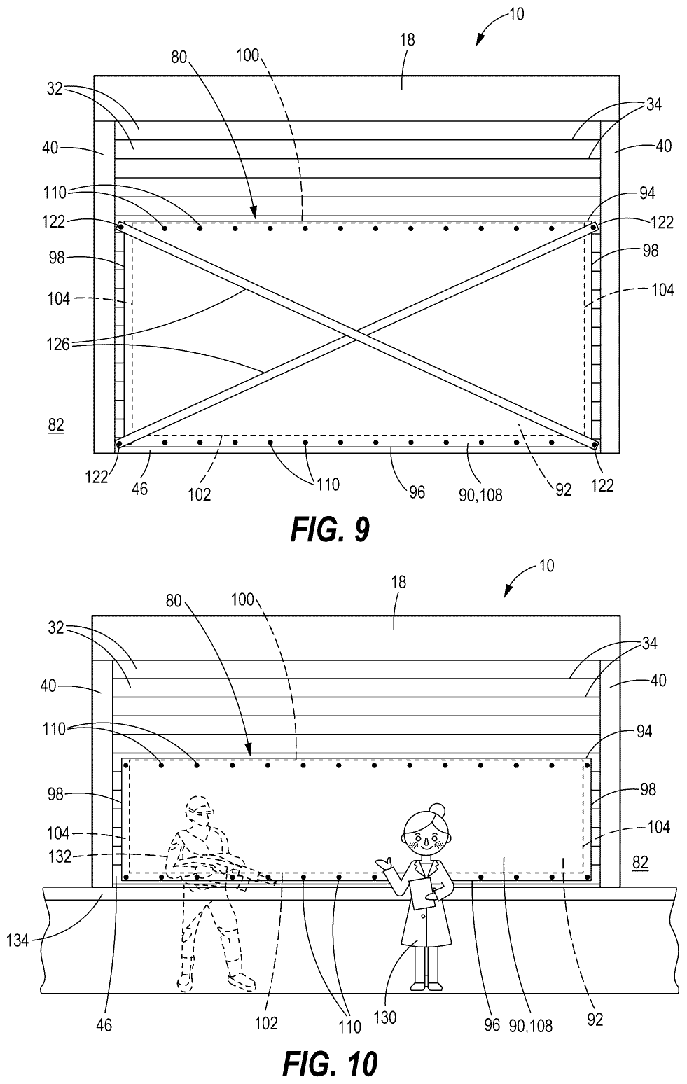

FIG. 8 illustrate a further alternative embodiment wherein a horizontal panel support strap 124 may be disposed approximately midway between the panel upper end 94 and the panel lower end 96 and attached to a corresponding shutter slat 94 by attachment mechanisms 122 beyond the panel lateral sides 98. FIG. 9 illustrates another alternative embodiment wherein diagonal panel support straps 126 may extend across the ballistic panel cover 90 to provide support to the ballistic panel 80. Those skilled in the art will understand that more or fewer panel support straps 120, 124, 126 may be installed to support the ballistic panel 80, and that combinations of the panel support straps 120, 124, 126 maybe installed as necessary to provide desired support for the ballistic panel 80. In one embodiment, a plurality of vertical panel support straps 120 and a plurality of horizontal panel support straps 124 may be installed and connected to each other in a manner similar to a cargo net to support the ballistic panel 80. Additional alternative configurations of panel support straps 120, 124, 126 are contemplated.

The ballistic panels 80 in accordance with the present disclosure provide flexibility in implementation to enhance ballistic protection while adding minimal cost and weight to the rolling shutter assembly 10. In many implementations, especially commercial settings, the covered opening is significantly taller than the people that may be in the area of the opening. Consequently, a ballistic panel 80 may not need to extend to the top of the opening and the shutter curtain assembly 10. As shown in FIG. 3, a protected person 130 and an assailant 132 may be substantially shorter than the opening covered by the shutter curtain 30. The ballistic panel 80 may be installed with the upper panel end 94 at a height where it is impractical for the assailant 132 to fire over the ballistic panel 80 and hit the protected person 130. With this installation, the cost and weight of the ballistic panel 80 between the panel upper end 94 and the shutter housing are eliminated. As further shown in FIG. 10, where the rolling shutter curtain 10 covers the opening at a counter 134, such as a pharmacy counter 134, the size of a ballistic panel 80 used to protect the workers 130 behind the counter from the assailant 132 is minimal.

The design of the ballistic panels 80 in accordance with the present disclosure may facilitate efficient manufacturing to produce ballistic panels 80 with standardized heights and widths so that more expensive customized installations can be reduced. For example, the ballistic panels 80 may be manufacture to a standard 84 inch height, for example, for floor-to-ceiling rolling protective shutters 10, and to a standard 36 inch height, for example, for counter top-to-ceiling rolling protective shutters 10. In the event that protection may be necessary to a greater height, an additional ballistic panel 80 may be installed on the shutter curtain 30 above the standard ballistic panel 80. The upper and lower ballistic panels 80 may abut at the adjacent panel ends 94, 96, or the panel lower end 96 of the upper ballistic panel 80 may extend below and overlay the panel upper end 94 of the lower ballistic panel 80 if necessary prevent projectiles from passing between the ballistic panels 80. In a similar manner, the ballistic panels 80 may be manufactured to standard widths such as 60 inches, for example. For wider shutter curtains 30, ballistic panels 80 may be installed side-by-side with the adjacent panel lateral sides 98 abutting or overlapping as necessary to provide the desired protection.

While the ballistic panels 80 are illustrated and described as being installed on the rolling shutter assembly 10 having the shutter curtain 30 formed by slats 32 connected by hinges 34 and having ends retained by the side tracks 40, those skilled in the art will understand that the ballistic panels 80 in accordance with the present disclosure may be installed on other types of rolling shutter assemblies. For example, the ballistic panel 80 may be installed on a shutter curtain fabricated from a sheet of durable fabric that is not easily penetrated by projectiles. The fabric shutter curtain may have lateral edges engaged by side tracks to provide end retention using mechanisms such as boltropes as disclosed in U.S. Pat. No. 10,209,036, issued to Rose, Jr. et al. on Feb. 19, 2019, entitled “Ballistic Shade System.”

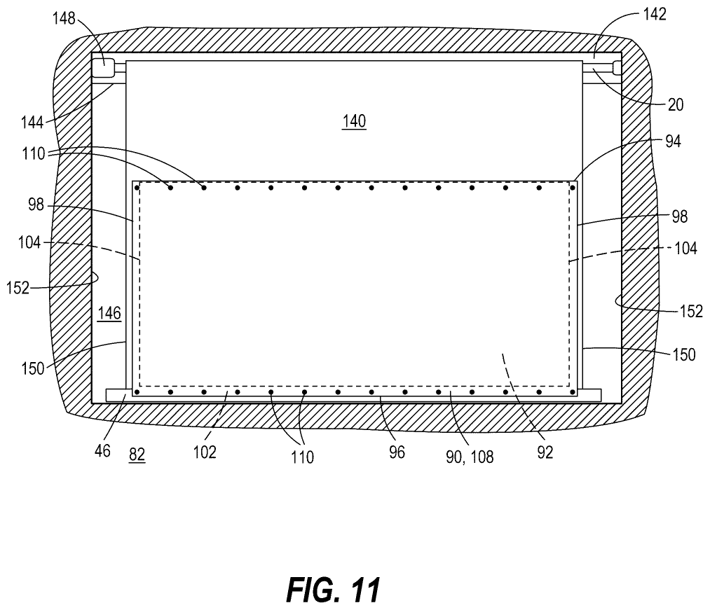

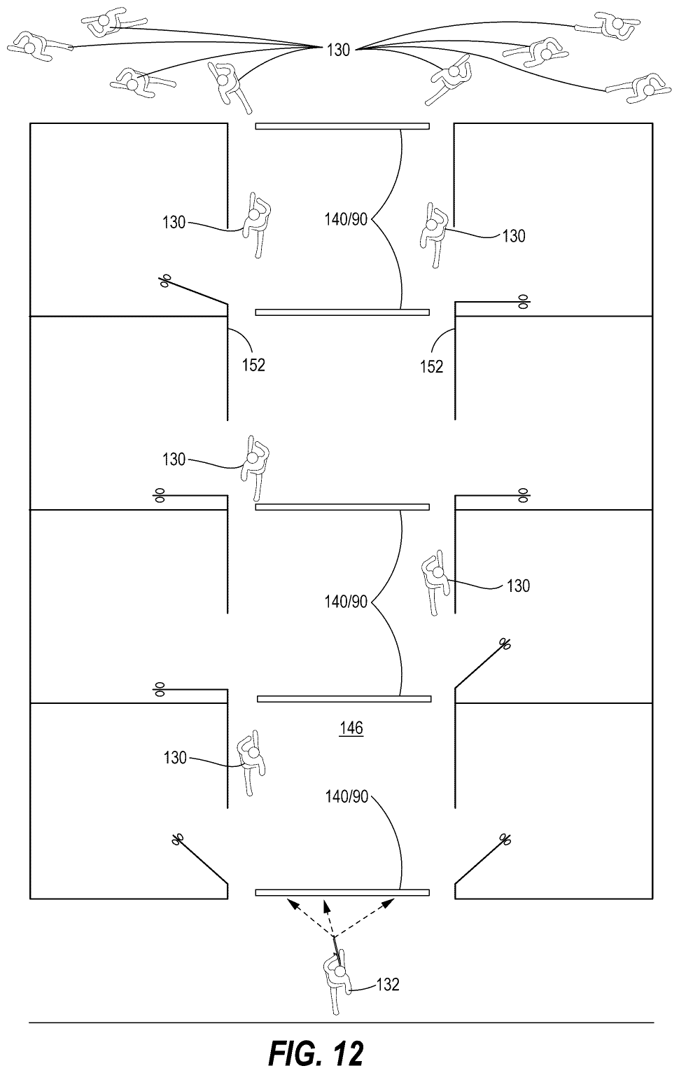

Alternatively, the lateral edges of the fabric shutter curtain having the ballistic panel 80 installed may be unrestrained. Such a design may be advantageous where the ballistics reinforced shutter curtain will partially cover an opening, such as a hallway, while allowing occupants to retreat by running around the edges of the shutter curtain. FIG. 11 illustrates an example of such an implementation where a shutter curtain 140 may drop down from a recess 142 in a ceiling 144 of the hallway 146 in the event of an emergency. A shutter support member 20 and a motor 148 may be mounted within the recess 142 and configured to rotate the shutter support member 20 to roll up and unroll the shutter curtain 140. The ballistic curtain 80 may be attached to the shutter curtain 140 by rivets 110 in a similar manner as described above or by any other appropriate attachment mechanisms. When the shutter curtain 140 is deployed as shown, curtain lateral edges 150 of the shutter curtain 140 may be spaced from walls 152 of the hallway 146 by a sufficient distance to allow occupants 130 to run around the shutter curtain 140 as they retreat from an assailant 132 or other type of ballistic emergency. As shown in FIG. 12, the hallway 146 may be outfitted with a plurality of ballistic curtains 140 to provide protection for the fleeing occupants 130 while slowing the advance of the assailant 132.

### INDUSTRIAL APPLICABILITY

The rolling shutter assemblies reinforced by ballistic panels 80 in accordance with the present disclosure are able to effectively roll up and unroll in the manner of existing non-reinforced rolling shutter assemblies while facilitating rapid deployment of the protective barriers for occupants of a facility in emergency situations. By not laminating or otherwise forming the ballistic sheets 92 into a monolithic structure, the ballistic sheets 92 can move relative to each other so that each ballistic sheet 92 can roll up onto the shutter support member 20 at its own rate to tightly roll up the shutter curtain 30, 140 and ballistic panel 80 without bunching and rippling. The weight and expense of the reinforced rolling shutter assembly can be conserved by installing the ballistic panel 80 only to the height required to protect occupants from ballistic events as opposed to covering up to the top of the opening. Smaller ballistic panels 80 reduce weight, which can allow for the use of smaller motors, and limit the additional material being rolled up on to the shutter support member 20 and corresponding size of the shutter housing required to fit the rolled up shutter curtain 30, 140. Those skilled in the art will also appreciate that the ballistic panels 80 in accordance with the present disclosure may be retrofit on existing rolling shutter assemblies to convert potentially vulnerable openings into protective barriers that are resistant to ballistic events.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A ballistic panel for a rolling shutter assembly covering an opening, comprising:
a ballistic panel cover; and
a plurality of ballistic sheets disposed within the ballistic panel cover, wherein each ballistic sheet is fabricated from a high-strength material and has a sheet upper edge, a sheet lower edge and oppositely disposed sheet lateral edges, wherein the plurality of ballistic sheets are attached to each other proximate the sheet upper edges and are not attached to each other along the sheet lower edges and the sheet lateral edges such that the plurality of ballistic sheets slide relative to each other when the plurality of ballistic sheets are rolled up around the sheet upper edges.

2. The ballistic panel according to claim 1, wherein the ballistic panel cover comprises a cover inside sheet and a cover outside sheet with the plurality of ballistic sheets disposed between the cover inside sheet and the cover outside sheet.

3. The ballistic panel according to claim 2, wherein the cover inside sheet and the cover outside sheet are connected at a panel upper end of the ballistic panel.

4. The ballistic panel according to claim 2, wherein the cover inside sheet and the cover outside sheet are connected at a panel lower end of the ballistic panel.

5. The ballistic panel according to claim 1, wherein the ballistic panel cover is attached to the plurality of ballistic sheets proximate the sheet upper edges and a panel upper end of the ballistic panel.

6. The ballistic panel according to claim 1, wherein the plurality of ballistic sheets is connected proximate the sheet upper edges by a plurality of rivets.

7. The ballistic panel according to claim 1, wherein the high-strength material is one of Kevlar®, Spectra Shield®, Dyneema®.

8. A rolling shutter assembly for covering an opening of a structure, the rolling shutter assembly comprising:
a shutter support member mounted at a top wall of the opening;
a shutter curtain coupled to the shutter support member so that rotation of the shutter support member rolls the shutter curtain onto and unrolls the shutter curtain from the shutter support member; and
a ballistic panel having a panel upper end, a panel lower end and oppositely disposed panel lateral sides, the ballistic panel comprising a plurality of ballistic sheets, wherein each ballistic sheet is fabricated from a high-strength material and has a sheet upper edge, a sheet lower edge and oppositely disposed sheet lateral edges, wherein the plurality of ballistic sheets are attached to each other and to the shutter curtain proximate the sheet upper edges and the plurality of ballistic sheets are not attached to each other along the sheet lower edges and the sheet lateral edges such that the plurality of ballistic sheets slide relative to each other when the shutter curtain and the ballistic panel are rolled up around the shutter support member.

9. The rolling shutter assembly according to claim 8, wherein the shutter curtain comprises a plurality of individual slats and a plurality of hinges interconnecting the plurality of individual slats, wherein the ballistic sheets are attached proximate the sheet upper edges to one of the slats with the panel lower end disposed proximate a bottom end of the shutter curtain.

10. The rolling shutter assembly according to claim 8, wherein the ballistic panel comprises a ballistic panel cover having the plurality of ballistic sheets disposed therein.

11. The rolling shutter assembly according to claim 10, wherein the ballistic panel cover is attached to the shutter curtain proximate the panel bottom end.

12. The rolling shutter assembly according to claim 8, wherein the ballistic panel comprises a ballistic panel cover having a panel outside sheet on an opposite side of the plurality of ballistic sheets from the shutter curtain, wherein the panel outside sheet is attached to the shutter curtain proximate the panel upper end and the panel lower end.

13. The rolling shutter assembly according to claim 8, comprising a pair of side tracks each having a U-shaped channel, each of the pair of side tracks mounted to a corresponding side wall of the opening such that curtain lateral edges of the shutter curtain are received within the U-shaped channels when the shutter curtain is unrolled from the shutter support member to cover the opening, and wherein the side tracks engage the curtain lateral edges to prevent the curtain lateral edges from being pulled out of the side tracks.

14. The rolling shutter assembly according to claim 8, wherein the plurality of ballistic sheets is attached to the shutter curtain by a plurality of rivets spaced along the sheet upper edges.

15. A ballistic curtain for covering an opening of a structure, comprising:
a shutter support member mounted at a top wall of the opening;
a shutter curtain coupled to the shutter support member, the shutter curtain comprising a plurality of individual slats and a plurality of hinges interconnecting the plurality of individual slats;
a pair of side tracks each having a U-shaped channel, each of the pair of side tracks mounted to a corresponding one of the opening side walls such that ends of the plurality of individual slats are received within the U-shaped channels when the shutter curtain is unrolled from the shutter support member to cover the opening; and
a ballistic panel having a panel upper end, a panel lower end and oppositely disposed panel lateral sides, the ballistic panel comprising a plurality of ballistic sheets, wherein each ballistic sheet is fabricated from a high-strength material and has a sheet upper edge, a sheet lower edge and oppositely disposed sheet lateral edges, wherein the plurality of ballistic sheets are attached to each other and to one of the slats proximate the sheet upper edges and the plurality of ballistic sheets are not attached to each other along the sheet lower edges and the sheet lateral edges such that the plurality of ballistic sheets slide relative to each other when the shutter curtain and the ballistic panel are rolled up around the shutter support member.

16. The rolling shutter assembly according to claim 15, wherein the ballistic panel comprises a ballistic panel cover having the plurality of ballistic sheets disposed therein.

17. The rolling shutter assembly according to claim 16, wherein the ballistic panel cover is attached to the shutter curtain proximate the panel bottom end.

18. The rolling shutter assembly according to claim 15, wherein the ballistic panel comprises a ballistic panel cover having a panel outside sheet on an opposite side of the plurality of ballistic sheets from the shutter curtain, wherein the panel outside sheet is attached to the shutter curtain proximate the panel upper end and the panel lower end.

19. The rolling shutter assembly according to claim 15, wherein the side tracks engage the ends of the plurality of individual slats to prevent the slats from being pulled out of the side tracks.

20. The rolling shutter assembly according to claim 15, wherein the plurality of ballistic sheets is attached to the one of the slats by a plurality of rivets spaced along the sheet upper edges.
